(19) United States
(12) Patent Application Publication
(10) Pub. No.: US 2024/0300788 A1
(43) Pub. Date: Sep. 12, 2024

(54) LIFTING TRANSPORTER DEVICE AND ASSOCIATED SYSTEMS AND METHODS

(71) Applicant: Intelliport Corporation, Becker, MN (US)

(72) Inventor: Melvin Dean Terry, Mount Vernon, WA (US)

(21) Appl. No.: 18/596,558

(22) Filed: Mar. 5, 2024

Related U.S. Application Data
(60) Provisional application No. 63/450,609, filed on Mar. 7, 2023.

(51) Int. Cl. B66F 9/065; B60G 9/02; B66F 9/075; B66F 9/22

(52) U.S. Cl. CPC B66F 9/065; B60G 9/02; B66F 9/07559; B66F 9/07572; B66F 9/07581; B66F 9/22; B60G 2300/26

(57) ABSTRACT

Lifting transporter devices, and associated systems and methods are disclosed herein. Representative devices can have a plank-like configuration, with multiple devices fitting under a load to lift and move the load. A representative device includes an elongated body and a pair of drive trucks carried by the elongated body and positioned toward opposite ends of the elongated body. Each drive truck can include a pair of drive wheels and a lift device positioned and actuatable to raise the body between a first position and a second position. The device can further include one or more outrigger assemblies positioned between the drive trucks and having casters positioned laterally outwardly from the drive trucks. The casters are positionable to engage a surface on which the drive trucks are supported when the lift devices are in the first position, and disengage from the surface when the lift devices are in the second position.

### CROSS-REFERENCE TO RELATED APPLICATION(S)

The present application claims priority to U.S. Provisional Patent Application No. 63/450,609, filed Mar. 7, 2023, which is incorporated herein by reference in its entirety.

### TECHNICAL FIELD

The present technology is directed generally to lifting transporter devices, and associated systems and methods. Representative devices can have a plank-like configuration, with multiple devices fitting under a palletized load to lift and move the load.

### BACKGROUND

Existing devices for transporting heavy loads include forklifts and other heavy-duty industrial lifters or transporters. For example, one representative transporter, available from Wheelift® (www.wheelift.com), rolls underneath a load and lifts it. Multiple transporters can together lift a long load and transport the load in different directions to a selected destination under the control of an operator. However, such devices are typically large, and therefore may lack maneuverability. In addition, such lifting devices may not be easily distributed beneath a non-uniform load in a way that best supports the load. Accordingly, there remains a need for improved heavy-duty transporters.

### BRIEF DESCRIPTION OF THE DRAWINGS

FIG. 1A is a partially schematic and partially cut-away side view illustration of a device configured in accordance with embodiments of the present technology.

FIG. 1B is a partially schematic and partially cut-away end view illustration of the device shown in FIG. 1A.

FIG. 1C is a partially schematic and partially transparent, top view illustration of the device shown in FIG. 1A.

FIG. 2 is a partially schematic, oblique view of a drive truck for supporting devices of the type shown in FIGS. 1A-1C, in accordance with embodiments of the present technology.

FIG. 3 is a partially schematic, end view illustration of a drive truck of the type shown in FIG. 2, illustrating pivotable motion of the axle, in accordance with embodiments of the present technology.

FIG. 4 is a partially transparent top view illustration of multiple transporters positioned or being positioned beneath a load in accordance with embodiments of the present technology.

### DETAILED DESCRIPTION

The present technology is directed generally to lifting transporter devices, and associated systems and methods. In representative embodiments, a transporter has a plank-type configuration, with two trucks: one forward, and one aft. Each truck can include a single axle, with each axle carrying two wheels. Because the trucks are narrow and aligned along the centerline of the body of the transporter, the transporter can further include at least one outrigger assembly that provides lateral stability for the transporter as it moves into position to carry a load. Once the transporter has lifted the load, the outrigger assemblies may be unnecessary, and they can be stowed as part of the operation of lifting the load via the transporter.

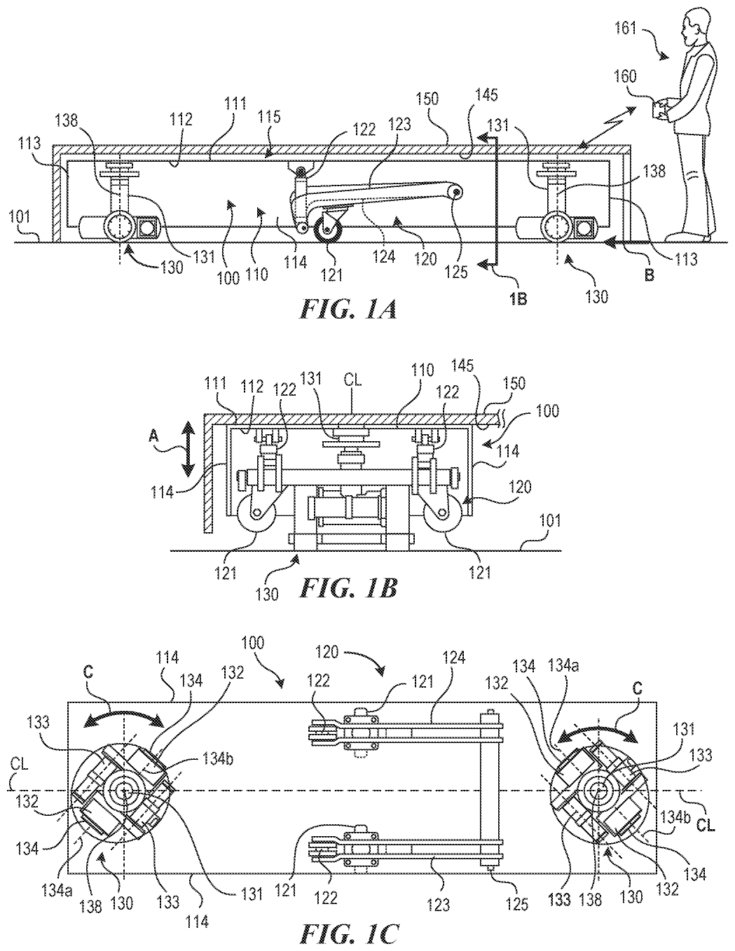

Specific details of several embodiments of the present technology are described below with reference to representative transporter devices to provide a thorough understanding of these embodiments. In other embodiments, the technology can be practiced in connection with devices that differ from those specifically shown and described below. Several details describing structures or processes that are well-known and often associated with industrial equipment are not set forth in the following description for purposes of brevity. Moreover, although the following disclosure sets forth several embodiments of different elements of the technology, several other embodiments of the technology can have different configurations and/or different components than those described in this section. As such, the technology may have other embodiments with additional elements, or without several of the elements described below with reference to FIGS. 1A-4.

In the Figures, representative embodiments of the technology are shown partially schematically. The Figures are not necessarily drawn to scale. Like reference numbers in the Figures refer to similar or identical components.

FIG. 1A is a partially schematic and partially cut-away side view illustration of a transporter 100, configured in accordance with embodiments of the present technology. The transporter 100 is positioned beneath a corresponding load 150 to raise and move the load. The load 150 may include a pallet supporting one or more various objects, for example, and/or it may include a self-supporting device capable of being lifted by embodiments disclosed herein.

As will be described further below, the transporter 100 can have a narrow profile, with one or more outrigger assemblies configured to provide stability when the transporter is positioned relative to the load 150. The outrigger assemblies can then be retracted (e.g., automatically) once the transporter 100 has engaged the load 150. The transporter 100 can include a body 110 having one or more sidewalls 114, such as two opposing sidewalls 114 (a far sidewall 114 is visible in FIG. 1A due to the cut-away depiction), one or more end walls 113, such as two opposing end walls 113, and a top wall 115. The top wall 115 can have a contact surface 111 (e.g., an upper surface). When the transporter 100 is raised, the contact surface 111 moves upwardly against the load 150 for the transporter 100 to lift and move the load 150. The top wall 115 can also have an oppositely-facing undersurface 112, to which the drive and support components of the transporter 100 are connected.

For example, with continued reference to FIG. 1A, the transporter 100 can include multiple drive trucks 130 (two are shown in FIG. 1A), each located toward a corresponding end wall 113 and attached or attachable to the body 110. Each truck 130 can include a lifting device 131, e.g., a hydraulic jack, that is attached to, or attachable to, the body 110 (e.g., to the top wall 115). The lifting device(s) 131 are operable to raise the top wall 115 to engage with the load 150 for transport. The transporter 100 can further include one or more outrigger assemblies 120 (a portion of one outrigger assembly 120 is visible in FIG. 1A), which provide lateral and/or “roll” support for the transporter 100 when the transporter 100 is not carrying a load. The one or more sidewalls 114 and the one or more end walls 113 can extend generally transversely and downwardly from the top wall 115 to at least partially enclose the drive trucks 130.

Each outrigger assembly 120 can include one or more arms, such as a first arm 123 and a second arm 124. The arms 123, 124 may be individually deemed outriggers within the outrigger assembly 120. The second arm 124 is illustrated partially in outline form because it is behind the first arm 123 in the perspective of FIG. 1A. Each of the arms 123, 124 can include and/or carry a movable surface contact portion for contacting a support surface 101 (hereinafter referred to as a “surface 101”) on which the transporter 100 is supported. In some embodiments, the movable surface contact portions can include pivoting casters 121, which may be similar to caster wheels on a grocer cart, for example. The first arm 123 can be pivotably connected to the second arm 124 at a pivot joint 125. One or each of the arms 123, 124 can be connected to a corresponding damping piston 122 or other damping device, which in turn can be connected to the top wall 115. As will be described in further detail below, the casters 121 can stabilize the transporter 100, and each damping piston 122 damps the motion of its corresponding caster 121. The damping piston 122 can have a maximum vertical travel that is less than the travel required to lift the load 150 off the surface 101 on which it is supported. In this manner, the outrigger assemblies 120 can automatically disengage from (e.g., spaced apart from) the surface 101 when the load 150 is lifted and the stabilizing effect of the outrigger assemblies 120 is no longer necessary. In other words, for example, as the trucks 130 lift the top wall 115 away from the surface 101, the damping piston(s) 122 can elongate due to gravity keeping the casters 121 on the surface 101, until the damping piston(s) reach their maximum vertical travel length and pull the casters 121 off of the surface 101 until the casters no longer contact the surface 101.

FIG. 1B is a partially schematic and partially cut-away end view of the transporter 100 shown in FIG. 1A taken generally along line 1B of FIG. 1A. In FIG. 1B, only one drive truck 130 is visible due to the perspective of the image. As shown in FIG. 1B, the drive truck 130 is positioned along an axial centerline CL of the body 110. The corresponding lift device 131 is also positioned along the centerline CL, and moves upwardly and downwardly, as indicated by arrow A, to lift the body 110 into and out of engagement with the load 150 and to move the load 150 off of, and onto, the surface 101.

In FIG. 1B, the lift device 131 has been actuated (e.g., raised) to engage the upper or contact surface 111 of the transporter 100 with a downwardly facing surface 145 of the load 150. The casters 121 are positioned laterally away from the centerline CL in FIG. 1B to provide lateral/roll stability for the transporter 100 when it is moved into position under the load 150, prior to actuation of the lift device(s) 131 (e.g., when the casters 121 are contacting the surface 101). But when the transporter 100 has engaged the load 150, the force of the load 150 across the contact surface 111 of the transporter 100 may resist or prevent the transporter 100 from tipping, so the casters 121 may no longer be necessary to provide stability. Accordingly, as shown in FIG. 1B, the casters 121 are lifted away from the surface 101 as the lift devices 131 engage the transporter 100 with the load 150.

FIG. 1C is a partially schematic and partially transparent top view of the transporter 100 shown in FIGS. 1A and 1B. FIG. 1C illustrates two drive trucks 130 positioned along the centerline CL. Each drive truck 130 includes one or more drive axles 134, e.g. two drive axles 134 extending along corresponding drive axes 134a, 134b, each drive axle 134 carrying a corresponding drive wheel 132 such that the drive wheels 132 rotate about drive axes. Each drive wheel 132 can be driven by a corresponding drive motor 133 (e.g., via the one or more drive axles 134 or another suitable connection between the drive wheel 132 and the corresponding drive motor 133). Each drive truck 130 can itself be pivoted about its own rotation or steering axis 138 along which the lift device 131 operates, as indicated by arrows C. For example, in particular embodiments, the drive trucks 130 can be rotated through an angle of ±45° from the centerline CL, or greater angles, for example, up to 90° from the centerline CL. In this manner, the transporter 100 can be moved in any direction. The transporter 100 can be pivoted around a single point, and can move in diagonal directions, as well as forward, backward, and laterally. In some embodiments, one or more of the outrigger assemblies 120 can be positioned entirely between the sidewalls 114.

Because the drive trucks 130 are positioned close to the centerline CL, and because the drive trucks 130 can rotate through large angles, the transporter 100 may not be laterally stable unless it is under load. Accordingly, as discussed above, the one or more outrigger assemblies 120 can deploy to provide stability while the transporter is moved into position to carry a load.

In operation (returning briefly to FIG. 1A), the transporter 100 is moved into position beneath the load 150, as indicated by arrow B (e.g., into or through an opening under the load 150). The lift devices 131 are activated to move the upper or contact surface 111 into contact with the load 150. The lift devices 131 continue to lift the load 150 higher until the load 150 has an appropriate clearance from the surface 101 on which the transporter 100 rests. At this point, the upward movement of the lifting device 131 can exceed the travel of the damping pistons 122, so that the casters 121 no longer contact the surface 101. Once the transporter 100 is in this configuration, the weight of the load 150 on the upper or contact surface 111 can provide the necessary lateral and roll stability for the transporter 100 to move the load 150 in any desired direction.

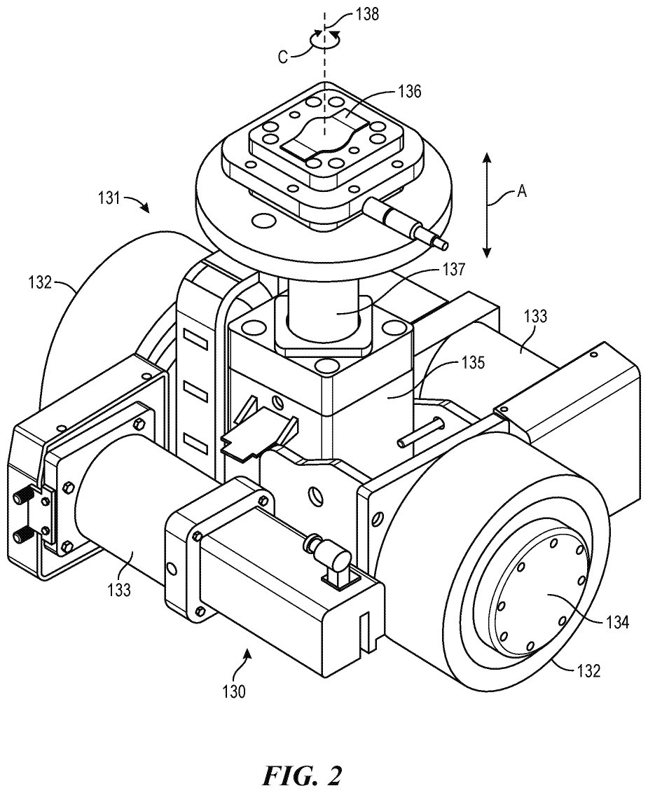

FIG. 2 is a partially schematic illustration of a representative drive truck 130 configured in accordance with embodiments of the present technology. The drive truck 130 can include two drive wheels 132, each connected to a corresponding drive axle 134. Each drive wheel 132 can be driven by a corresponding drive motor 133. In some embodiments, the drive motors 133 are synchronized to provide equal rotation to each drive wheel 132. In some embodiments, the individual drive motors 133 are independently operable to turn the drive truck 130 about the steering axis 138, is indicated by arrow C. For example, each drive wheel 132 can be drivable at different speeds and/or in different directions than the other drive wheel 132 to pivot the drive truck 130 about the steering axis 138. In other embodiments, a separate device (e.g., a steering motor) can be included to implement the steering feature. In any of these embodiments, the drive truck 130 can include a drive truck body 135 that houses and/or carries at least part (such as all) of the lift device 131 (and the steering motor, if any). The lift device 131 can include a lift piston 137 carrying a lift interface 136. The lift interface 136 can be connected or connectable to the undersurface 112 (see FIG. 1A) of the transporter 100. The lift piston 137 can be driven hydraulically (e.g., by a hydraulic cylinder and/or other device inside and/or supported by the drive truck body 135), and/or via other techniques, to raise and lower the lift interface 136, and therefore the transporter body 110, as indicated by arrow A.

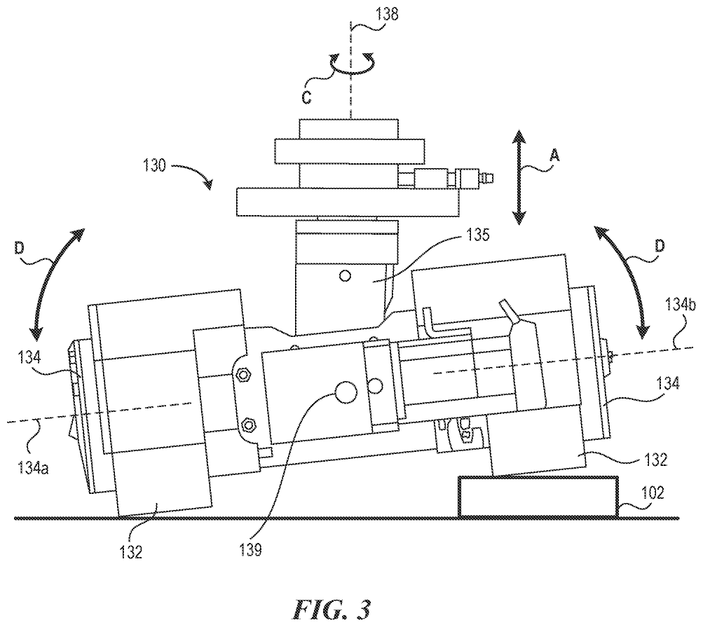

FIG. 3 is a partially schematic end view of a representative drive truck 130. As shown in FIG. 3, the drive axles 134 and the drive wheels 132 are pivotable relative to the drive truck body 135 about an axle pivot axis 139 that is transverse to the steering axis 138 and transverse to the drive axles 134, as indicated by arrows D. Accordingly, the drive axles 134 can tilt so that the drive truck 130 can move over uneven surfaces, and can accommodate motion over obstructions 102 in the path of the transporter 100. The entire transporter 100 (see FIG. 1A) can remain level or otherwise generally untilted as the drive axles 134 articulate relative to the drive truck body 135 (and relative to the remainder of the transporter 100) to reduce or eliminates load on the outrigger assemblies 120 while the transporter 100 passes over the obstruction 102. Accordingly, a feature of embodiments of the present technology is a stable transporter 100 that resists tipping under load and while not under load.

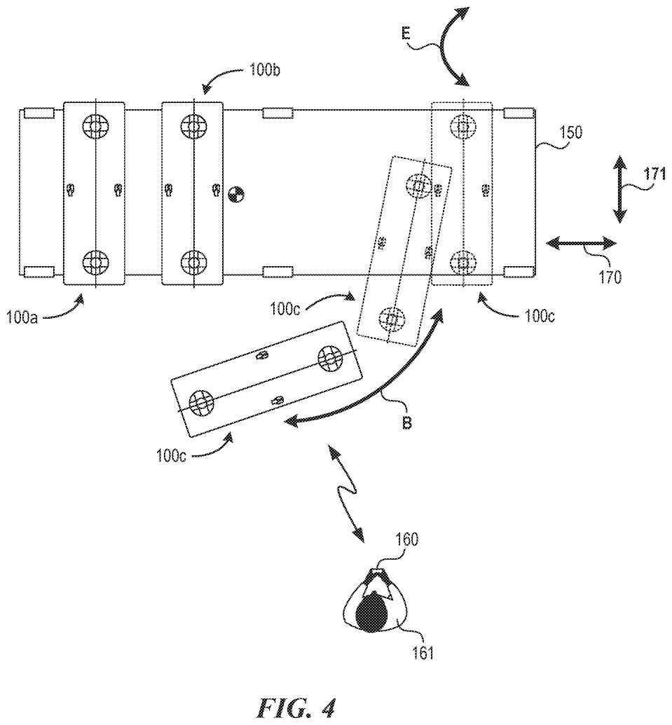

FIG. 4 is a partially schematic, partially transparent top view of the load 150 and multiple transporters 100 that are in position, or being moved into position, prior to lifting and moving the load 150. For example, two transporters 100a, 100b are already in their final positions under the load 150, and a third transporter 100c is shown in three sequential positions as it moves under the load 150. The two transporters 100a, 100b already under the load 150 are positionable under a particularly heavy portion of the load 150. The third transporter 100c is positionable under a relatively light portion of the load 150. An operator can select the relative positions of the transporters 100 (e.g., 100a, 100b, 100c) to fit the weight distribution of the load 150. Accordingly, a feature of embodiments of the present technology include flexibility for adjusting to non-uniform loads 150.

When the transporters 100 are in position, the operator 161 can use a controller 160 to drive the load 150 to a desired location. The motions of the individual transporters 100a-100c are synchronized via wireless communications from the controller 160 and the operator 161 to move the load 150 to a particular location, along a particular target path. The operator 161 can control the orientation of the load 150 as needed along the path as it moves. For example, the load 150 can be moved in a first direction 170 (e.g., orthogonal or otherwise transverse to the centerlines CL, see FIG. 1C), a second direction 171 (e.g., along the centerlines CL), and/or any other suitable direction. The load 150 is also rotatable (e.g., as indicated by arrow E).

One feature of transporters 100 configured in accordance with embodiments of the present technology is that they can have a narrow profile and can accordingly be placed at any of a multitude of locations beneath a load 150. The operator 161 can place multiple transporters 100 close to each other beneath a heavy portion of the load 150, and fewer transporters 100 at positions where the load is not as heavy. If the narrow profile of the transporters 100 results in the transporters 100 being unstable about a roll axis (e.g., the centerline CL) when not constrained by a load, the outrigger assemblies 120 can deploy to provide roll stability for the transporters 100. In addition, the damping pistons 122 can limit the degree of roll experienced by the transporter 100. Still further, the damping pistons 122 can have a range of motion that is less than the range of motion of the lift device 131 (e.g., less than a maximum extension length of the lift device 131). Accordingly, the outrigger assemblies 120 can automatically move out of the way and out of contact with the surface 101 when the transporter 100 is under load.

As used herein, the term “and/or,” as in “A and/or B” refers to A alone, B alone and both A and B. A similar manner of interpretation applies to the term “and/or” when used in a list of more than two terms. As used herein, the terms “generally,” “about” and “approximately” refer to values within 10% of the stated value. Numerical adjectives including “first” and “second,” or the like, as used in the present disclosure, do not convey hierarchy or specific features or functions. Rather, such numerical adjectives are intended to aid the reader in distinguishing between elements which may have similar nomenclature, but which may differ in position, orientation, or structure. Accordingly, such numerical adjectives may be used differently in the claims. For purposes of the present disclosure, a first element that is positioned “toward” an end of a second element is positioned closer to that end of the second element than to a middle or mid-length location of the second element. To the extent any materials incorporated herein by reference conflict with the present disclosure, the present disclosure controls.

From the foregoing, it will be appreciated that specific embodiments of the disclosed technology have been described herein for purposes of illustration, but that various modifications may be made without deviating from the technology. For example, the motors and/or lifting devices can be electrically powered, can include hydraulic actuators, and/or can have other configurations. Although damping devices can include the damping pistons 122, other damping devices can include any suitable device that has limited travel and, optionally, damping characteristics. Although each drive truck is described as having a pair of drive wheels, in some embodiments, a drive truck may only have one drive wheel and one corresponding drive motor. Certain aspects of the technology described in the context of particular embodiments may be combined or eliminated in other embodiments. Further, while advantages associated with certain embodiments of the disclosed technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

Many embodiments of the technology described herein may take the form of computer- or machine- or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured or constructed to perform one or more of the computer-executable instructions described herein. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including an LED display.

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

The following examples provide additional representative features of the present technology. Further examples of the present technology can include more, fewer, or different elements than the elements in these examples.
1. A transporter system, comprising:
an elongated body;
a pair of drive trucks carried by the elongated body and positioned toward opposite end of the elongated body, each drive truck including
   a pair of drive wheels; and
   a lift device positioned and actuatable to raise the body between a first position and a second position; and
a pair of outriggers positioned between the drive trucks and having casters positioned laterally outwardly from the drive trucks, wherein the casters are positioned to engage a surface on which the drive trucks are supported when the lift devices are in the first position, and disengage from the surface when the lift devices are in the second position.
2. The transporter system of example 1 wherein the outriggers each include a damping piston, and wherein a throw of the damping piston is less than a distance between the first position and the second position.

I/We claim:

1. A transporter system comprising:
a top wall;
a pair of drive trucks supporting the top wall and positioned toward opposite ends of the top wall, wherein each drive truck includes a pair of drive wheels and a lift device positioned and actuatable to move the top wall between a first position and a second position that is higher than the first position; and
one or more outrigger assemblies movable to contact a support surface when the top wall is in the first position, and to be spaced apart from the support surface when the top wall is in the second position.

2. The transporter system of claim 1, wherein the one or more outrigger assemblies are positionable between the drive trucks.

3. The transporter system of claim 1, wherein at least one of the one or more outrigger assemblies comprises:
a first arm carrying a first movable surface contact portion for contacting the support surface; and
a second arm carrying a second movable surface contact portion for contacting the support surface, wherein the second arm is movably connected to the first arm at a joint.

4. The transporter system of claim 3, further comprising one or more damping devices connecting each of the first arm and the second arm to the top wall.

5. The transporter system of claim 3, wherein each of the first movable surface contact portion and the second movable surface contact portion includes a caster.

6. The transporter system of claim 1, further comprising (a) at least one sidewall connected to the top wall or (b) at least one end wall connected to the top wall.

7. The transporter system of claim 1, wherein the drive wheels of at least one of the drive trucks are pivotable about a pivot axis to tilt drive axles of the drive wheels relative to the support surface.

8. A transporter system, comprising:
a body; and
a plurality of drive trucks attachable to the body;
wherein at least one of the drive trucks comprises:
a first drive wheel;
a first drive motor operatively connected to the first drive wheel for driving the first drive wheel;
a second drive wheel;
a second drive motor operatively connected to the second drive wheel for driving the second drive wheel; and
a lift device actuatable to move the body away from a surface;
wherein the first and second drive wheels are pivotable about a pivot axis extending transversely to drive axes of the first and second drive wheels to tilt the drive axes relative to a support surface.

9. The transporter system of claim 8, further comprising:
one or more outrigger assemblies carried by the body and positionable to contact the support surface when the body is in a first position, and positionable to separate from the support surface when the body is in a second position that is higher than the first position.

10. The transporter system of claim 9, wherein at least one of the outrigger assemblies comprises:
an arm carrying a movable surface contact portion for contacting the support surface; and
one or more damping devices connecting the arm to the body.

11. The transporter system of claim 10, wherein at least one of the one or more damping devices has a maximum travel length that is less than a distance between the first position and the second position.

12. The transporter system of claim 10, wherein the movable surface contact portion comprises a caster.

13. The transporter system of claim 10, wherein the arm is a first arm, and wherein at least one of the outrigger assemblies comprises a second arm carrying a second movable surface contact portion, wherein the second arm is pivotably connected to the first arm.

14. The transporter system of claim 8, further comprising a wireless controller configured to control the first drive motor, the second drive motor, and the lift device.

15. The transporter system of claim 8, wherein the body comprises a top wall, one or more end walls, and one or more sidewalls to at least partially enclose the drive trucks.

16. The transporter system of claim 8, wherein the lift device comprises a hydraulic jack.

17. A method of moving a load, the method comprising:
(a) positioning a plurality of separate transporters under the load, wherein positioning the transporters comprises operating one or more drive motors to drive one or more drive wheels of each of the transporters;
(b) raising a body of each transporter to contact and lift the load, wherein raising each body comprises operating a lifting device attached to each body;
(c) lifting one or more outrigger assemblies away from a surface, wherein at least one of the bodies carries each of the one or more outrigger assemblies;
(d) operating the one or more drive motors to drive the one or more drive wheels to move the load along the surface; and
(e) lowering the bodies to lower the load until the load is supported on the surface.

18. The method of claim 17, wherein operating the one or more drive motors comprises operating the one or more drive motors to steer the transporters by at least one of:
(a) moving a first wheel in a first direction about an axis, and moving a second wheel in a second direction about the axis, wherein the second direction is opposite the first direction; or
(b) moving a first wheel at a first speed, and moving a second wheel at a second speed that is different from the first speed.

19. The method of claim 17, wherein lifting the one or more outrigger assemblies comprises lifting each of the outrigger assemblies by a distance greater than a maximum travel distance of the outrigger assemblies.

20. The method of claim 17, wherein lifting the one or more outrigger assemblies comprises:
supporting the one or more outrigger assemblies on one or more damping devices having a maximum travel length; and
separating the one or more outrigger assemblies from the surface when the one or more damping devices reach the maximum travel length.
